(19) United States
(12) Patent Application Publication
(10) Pub. No.: US 2017/0017380 A1
(43) Pub. Date: Jan. 19, 2017

(54) MOBILE ENABLING A WEB APPLICATION DEVELOPED WITHOUT MOBILE RENDERING CAPABILITIES

(71) Applicant: International Business Machines Corporation, Armonk, NY (US)

(72) Inventors: Mudit Mehrotra, New Delhi (IN); Samit Narula, Bangalore (IN)

(21) Appl. No.: 14/797,855

(22) Filed: Jul. 13, 2015

(51) Int. Cl. G06F 3/0484; H04L 29/08; H04B 1/3827

(52) U.S. Cl. CPC G06F 3/04847; H04B 1/3827; H04L 67/02

(57) ABSTRACT

A method for mobile enabling a web application, wherein the web application was developed without a mobile rendering capability is provided. The method may include intercepting a plurality of content between a web browser and a web application. The method may also include checking a user agent from which the intercepted plurality of content is being received. The method may further include determining whether the user agent is a mobile device based on the checking. The method may include modifying or replacing a plurality of parameters associated with the intercepted plurality of content based on the determination that the user agent is a mobile device. The method may also include deploying the modified or replaced parameters via a virtual mobile enabled web application.

### BACKGROUND

The present invention relates generally to the field of computers, and more particularly to web applications.

Legacy applications were developed during a time when the mobile platform was not a client platform. As such, there were a number of web applications developed across the world before the mobile or smartphone revolution and they are inherently “black-box” in nature due to the technology when they were developed and their age in terms of existence. Therefore, they do not have native capability of rendering correctly according to the mobile device's supported layout and navigation pattern.

### SUMMARY

According to one embodiment, a method for mobile enabling a web application, wherein the web application was developed without a mobile rendering capability is provided. The method may include intercepting a plurality of content between a web browser and a web application. The method may also include checking a user agent from which the intercepted plurality of content is being received. The method may further include determining whether the user agent is a mobile device based on the checking. The method may include modifying or replacing a plurality of parameters associated with the intercepted plurality of content based on the determination that the user agent is a mobile device. The method may also include deploying the modified or replaced parameters via a virtual mobile enabled web application.

According to another embodiment, a computer system for mobile enabling a web application, wherein the web application was developed without a mobile rendering capability is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include intercepting a plurality of content between a web browser and a web application. The method may also include checking a user agent from which the intercepted plurality of content is being received. The method may further include determining whether the user agent is a mobile device based on the checking. The method may include modifying or replacing a plurality of parameters associated with the intercepted plurality of content based on the determination that the user agent is a mobile device. The method may also include deploying the modified or replaced parameters via a virtual mobile enabled web application.

According to yet another embodiment, a computer program product for mobile enabling a web application, wherein the web application was developed without a mobile rendering capability is provided. The computer program product may include one or more computer-readable storage devices and program instructions stored on at least one of the one or more tangible storage devices, the program instructions executable by a processor. The computer program product may include program instructions to intercept a plurality of content between a web browser and a web application. The computer program product may also include program instructions to check a user agent from which the intercepted plurality of content is being received. The computer program product may further include program instructions to determine whether the user agent is a mobile device based on the checking. The computer program product may include program instructions to modify or replace a plurality of parameters associated with the intercepted plurality of content based on the determination that the user agent is a mobile device. The computer program product may also include program instructions to deploy the modified or replaced parameters via a virtual mobile enabled web application.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating the steps carried out by a program that provides the capability of mobile enabling a web application developed without mobile rendering capabilities;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to web applications. The following described exemplary embodiments provide a system, method and program product to, among other things, provide a capability to mobile enable web applications that are not natively developed for mobile devices, such as smart phones. Therefore, the present embodiment has the capacity to improve the technical field of web applications by using an extensible framework in a manner which does not need knowledge of the existing application and also requires a lot less investment of time and resources as compared to rewriting the application completely. Additionally, the present embodiment may not need to modify an existing application and therefore, does not need the knowledge of the existing application. Furthermore, the present embodiment may not require a large project planning process and resources and investment for delivering the same. More specifically, the present embodiment may add a layer or a “bridge” in between a web application and a browser and as such, render the application on the browser through a managed iFrame which may have two primary parts which are on the browser side and on the server side. Therefore, a framework may be created which will enable injection of plug-ins or custom code that can intercept the flow of content between the browser and the web application.

As previously described, legacy applications were developed during a time when the mobile platform was not a client platform. As such, there were a number of web applications developed across the world before the mobile or smartphone revolution and they are inherently “black-box” in nature due to the technology when they were developed and their age in terms of existence. Therefore, they do not have native capability of rendering correctly according to the mobile device's supported layout and navigation pattern.

An alternative is to discard or redesign such legacy applications for mobile enablement. However, mobile enablement is typically an aspect of client-side technologies and replacing this aspect in a legacy application may be difficult outside its current deployment. As such, current approaches to solve this problem are may include modifying the existing web application. However many times this is not feasible because the people who might have developed the application are not working for the organization anymore and hence it may become time consuming and risky. Additionally, another option to solve this problem may be to completely discard or rewrite the application. However, such a solution requires a new project plan, resources identification, etc. and as such, may involve excessive time and cost. As such, it may be advantageous, among other things, to provide a way by which it is possible to mobile enable web applications that are not natively developed for mobile devices, such as smart phones.

According to at least one implementation, the resources served by a content provider are received by the http-client of a reverse proxy and the reverse proxy may have an interceptor module that orchestrates mobile enablement. Thus, based on generally identified rules and User experience (UX) designer's input some of the resources may either be replaced or modified. Additionally, references to client-side resources supporting mobile design may be inserted in the markup and the re-calculated UX except the html content may be cached. As such, the result may be a virtual mobile enabled deployment of a web application not inherently built for mobile.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to provide a capability to mobile enable web applications that are not natively developed for mobile devices, such as smart phones.

According to at least one implementation, the present embodiment may add a layer (i.e., a “bridge”) in between the web application and the browser and render the application on the browser through a managed inline frame (iFrame). The iFrame is an HTML document embedded inside another HTML document on a website. The iFrame HTML element is often used to insert content from another source, such as an advertisement, into a web page. According to the present embodiment, the iFrame has two primary parts with one part being on the browser side and on the other primary part being on the server side. As such, a framework may be created which may enable injection of plug-ins or custom code that can intercept the flow of content between the browser and the web application. According the present embodiment, this interception can happen in the request phase, the response phase, or both.

More specifically, the main action happens on a bridge in between the browser and the web application. Thus, by introducing the bridge in between the browser and the web application, an opportunity may be created that allows the request or response parameters to be modified, as well as the web content that is passing through the bridge. Hence, the present embodiment may intercept and check the user agent from which the request is being received. Then, if the User Agent indicates a mobile device, such as a smart phone, multiple events may be implemented that may modify the returning content.

For example, according to at least one implementation, the response may be intercepted and an algorithm may be run to modify the response received as per the layout of the device where the request originated. According to an alternate implementation, the response can be intercepted and additional code may be introduced which could add device capability and convert the web application into a hybrid application.

The present embodiment may rely on the usage of a reverse proxy pattern and responsive web design using media queries or an adaptive mechanism. As such, when the browser requests for a web page that is fetched through a reverse proxy intermediary, then the reverse proxy has a chance on its end to create a session context and filter requests and responses during the web application interactions. Therefore, the reverse proxy intermediary can block as well as inject into the cascading style sheet (CSS). CSS is a style sheet language used for describing the look and formatting of a document written in a markup language. This reverse proxy intermediary capability can be used to introduce elements of responsive web design into a legacy application by introspecting and modifying its markup though not the document object model (DOM) structure per se. The DOM is a cross-platform and language-independent convention for representing and interacting with objects in HTML, XHTML, and XML documents. The nodes of every document are organized in a tree structure, called the DOM tree.

The present embodiment may be implemented as an interceptor component running over the reverse proxy. The interceptor component may filter the response for a web page and extract out any style declarations from the web page markup and write the extracted style declarations to a new CSS file. Additionally, the present embodiment may also intercept the response carrying any CSS file for the browser. The present embodiment may be implemented as a manual or automated process. Accordingly, static resources available to the interceptor can be created or dynamic rule based modifications can be performed. The blocked CSS is enhanced according to predefined general and specific rules to add additional styling information regarding layouts etc. Then, the markup may be enhanced by introducing media queries and CSS, and other resources served as per the queries. As a result, the modified resources are either cached or regenerated on every request. An alternate implementation may be to use adaptive web design techniques while the rest of the process as outlined above can remain similar. As such, various Java Script (js) libraries that help in adaptation may be introduced in the markup and the CSS may be manipulated according to predefined rules to receive the desired result.

According to at least one implementation, the present embodiment may provide a way (that does not need any additional resource) for rendering converted mobile content on the fly. As such, the present embodiment does not require any additional storage and can be used on the fly, on any website which makes its utility to be potentially infinite. Furthermore, the present embodiment does not use a representational state transfer (REST) (REST is a software architecture style consisting of guidelines and best practices for creating scalable web services) based mechanism or segregate content based on it being static or dynamic and there is no packaging involved. Rather, an overlay mechanism may be implemented which not only modifies the display but adapts behavior as per the mobile device. Additionally, the mechanism can work on the server to parse the DOM, rewrite CSS and js, and can also use a client-side mechanism to detect device characteristics and transform UX and behavior. The present embodiment does not create a snapshot or store the web site content, nor does it delete and add any structural parts of the web site. However, the present embodiment actually converts the desktop based website into a “mobile site” without any knowledge or changing of the website's design and as such, provides a generic way for the present embodiment to be applied for any website automatically to render it on a mobile device automatically. Hence, the present embodiment does not require any effort to be done for every different website. For example, the present embodiment does not require any change in the existing website, nor does the present embodiment need a new host, etc. Hence, the present embodiment may be a faster method which also does not require any additional resource as mentioned above. Furthermore, the present embodiment is not concerned with creating a mobile friendly web site and hosting it (as with some current techniques), but rather adapting the original web site on the fly to be rendered on a mobile device.

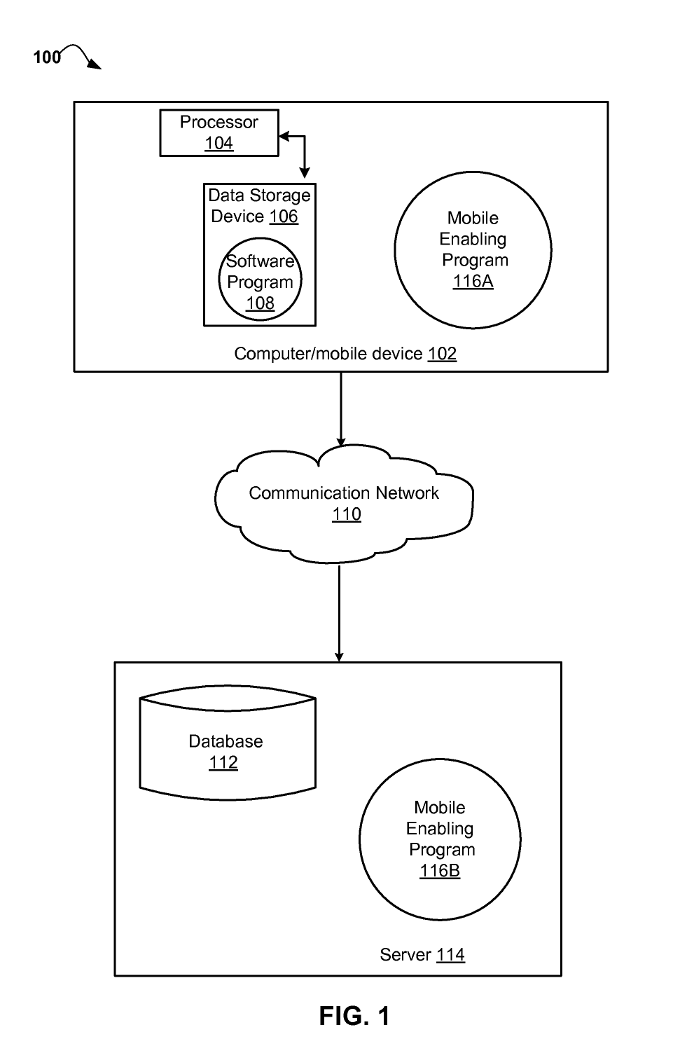

Referring to FIG. 1, an exemplary networked computer environment 100 in accordance with one embodiment is depicted. The networked computer environment 100 may include a computer/mobile device 102 with a processor 104 and a data storage device 106 that is enabled to run a software program 108, such as a web application (a web application is any software that runs in a web browser) and a Mobile Enabling Program 116A. The networked computer environment 100 may also include a server 114 that is enabled to run a Mobile Enabling Program 116B that may interact with a database 112 and a communication network 110. The networked computer environment 100 may include a plurality of computer/mobile device 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

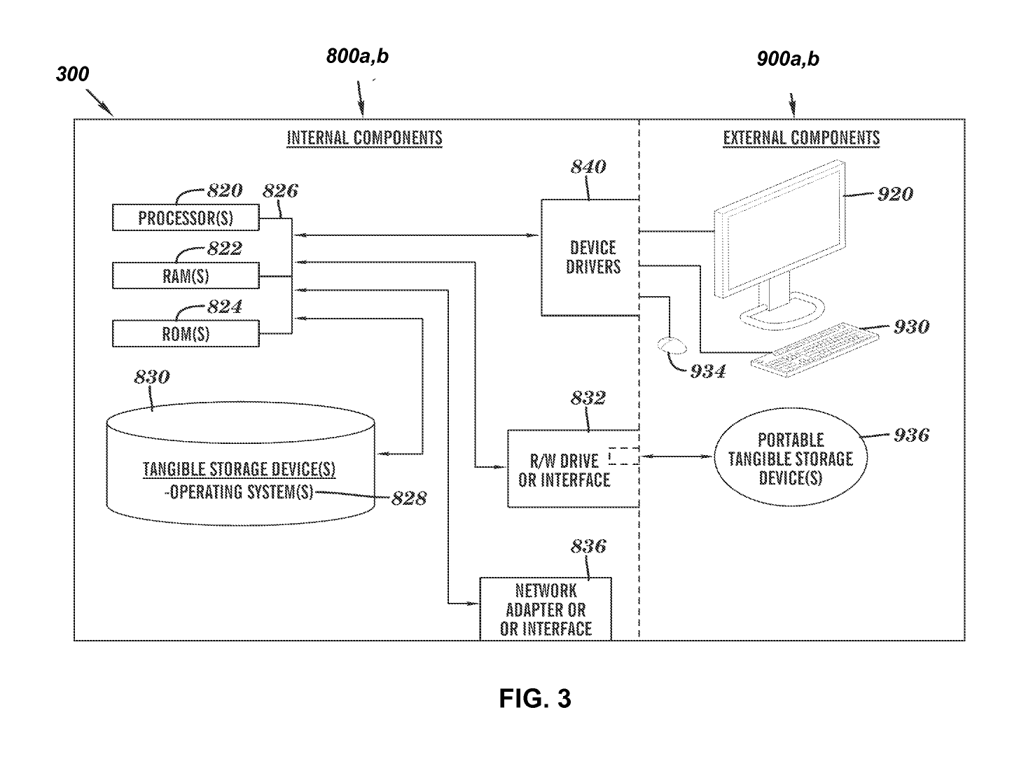

The client computer/mobile device 102 may communicate with the Mobile Enabling Program 116B running on server computer 114 via the communications network 110. The communications network 110 may include connections, such as wire, wireless communication links, or fiber optic cables. As will be discussed with reference to FIG. 3, server computer 114 may include internal components 800a and external components 900a, respectively, and client computer/mobile device 102 may include internal components 800b and external components 900b, respectively. Client computer/mobile device 102 may be, for example, a mobile device, a telephone, a personal digital assistant, a netbook, a laptop computer, a tablet computer, a desktop computer, or any type of computing devices capable of running a program, accessing a network, and accessing a database 112. According to various implementations of the present embodiment, the Mobile Enabling Program 116A, 116B may interact with a database 112 that may be embedded in various storage devices, such as, but not limited to a computer/mobile device 102 102, a networked server 114, or a cloud storage service.

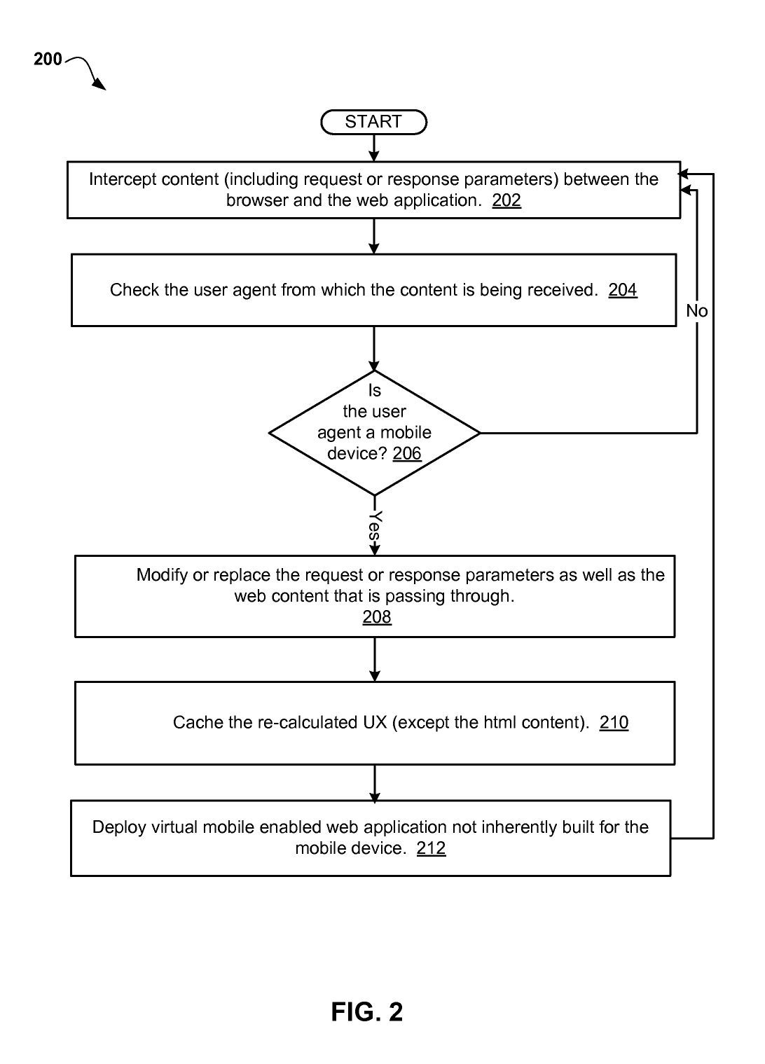

As previously described, the client computer/mobile device 102 may access the Mobile Enabling Program 116B, running on server computer 114 via the communications network 110. For example, a user using a client computer/mobile device 102 may access the Mobile Enabling Program 116A, 116B, running on client computer/mobile device 102, and server computer 114, respectively via the communications network 110. For example, a user using an application program 108 (e.g., Firefox®) (Firefox and all Firefox-based trademarks and logos are trademarks or registered trademarks of Mozilla and/or its affiliates) running on a client computer/mobile device 102 may connect via a communication network 110 to the Mobile Enabling Program 116B which may be running on server computer 114. The user may utilize the Mobile Enabling Program 116A, 116B to provide a capability to mobile enable web applications that are not natively developed for mobile devices, such as smart phones. The Mobile Enabling method is explained in more detail below with respect to FIG. 2.

Referring now to FIG. 2, an operational flowchart 200 illustrating the steps carried out by a program that provides the capability of mobile enabling a web application without mobile rendering capabilities. As previously described, the Mobile Enabling Program 116A, 116B (FIG. 1) may mobile enable a web application (via a reverse proxy) without modifying the application or installing any application in the device.

According to the present embodiment, a layer or a “bridge” may be added in between the web application and the browser and the application may be rendered on the browser through a managed iFrame which has two primary parts that are located on the browser side and on the server side. As such, the present embodiment may create a framework which may enable injection of plug-ins or custom code that can intercept the flow of content between the browser and the web application. According to various implementations, the interception can happen either in the request phase, the response phase, or both. However, the main action would be happening on the bridge in between the browser and the web application. By introducing a bridge in between, an opportunity is created to modify with the request or response parameters as well as the web content that is passing through. Hence, the request or response may be intercepted via an interceptor module and the user agent from which if the request is being received may be checked. If the User Agent indicates a mobile device, such as a smart phone, multiple things can be made to happen which can completely modify the returning content.

Therefore with respect to FIG. 2 at 202, the Mobile Enabling Program 116A, 116B (FIG. 1) intercepts content, including parameters associated with a request or a response between a web browser and application. According to at least one implementation, the present embodiment relies on the usage of reverse proxy pattern and responsive web design using media queries or an adaptive mechanism. When the browser requests for a web page that is fetched through a reverse proxy intermediary, then the reverse proxy has a chance on its end to create a session context and filter requests and responses during the web application interactions. Therefore, the resources served by a content provider are received by the http-client of the reverse proxy and the reverse proxy may have an interceptor module that orchestrates mobile enablement.

Next at 204, the Mobile Enabling Program 116A, 116B (FIG. 1) checks the user agent from which the content is being received and determines at 206, whether the user agent is a mobile device. If at 206, it is determined that the user agent is not a mobile device, then the method may continue back to previously described step 202 to continue intercepting content between the browser and a web application.

However, if at 206 it is determined that the user agent is a mobile device, then at 208 the Mobile Enabling Program 116A, 116B (FIG. 1) modifies or replaces the request or response parameters as well as the web content that is passing through. According to at least one implementation of the present embodiment, the response may be intercepted by an inceptor component running over the reverse proxy and an algorithm may be run to modify the response received as per the layout of the device where the request originated. However, in an alternate implementation, the response may be intercepted and additional code introduced which could even add device capability and convert the web application into a hybrid application. The present embodiment is implemented with the use of a reverse proxy intermediary that can block as well as inject CSS and can be used to introduce elements of responsive web design into a legacy application by introspecting and modifying its markup though not the DOM structure per se.

For example, according to at least one implementation, some of the resources may either be replaced or modified based on generally identified rules and UX designer's input. Additionally, references to client-side resources supporting mobile design may be inserted in the markup and the re-calculated UX, except the html, content may be cached. As such, the result may be a virtual mobile enabled deployment of a web application not inherently built for a mobile platform.

The interceptor component may filter the response for a web page and extract out any style declarations from the web page markup and write the extracted style declarations to a new CSS file. Additionally, the present embodiment may also intercept the response carrying any CSS file for the browser. The present embodiment may be implemented as a manual or automated process. Accordingly, static resources available to the interceptor can be created or dynamic rule based modifications can be performed. The blocked CSS is enhanced according to predefined general and specific rules to add additional styling information regarding layouts etc. Then, the markup may be enhanced by introducing media queries and CSS, and other resources served as per the queries.

Then at 210, the Mobile Enabling Program 116A, 116B (FIG. 1) caches the recalculated UX, with the exception of the html content. According to the present embodiment, the modified resources are either cached or regenerated on every request. An alternate implementation may be to use adaptive web design techniques while the rest of the process as outlined above can remain similar. As such, various Java Script (js) libraries that help in adaptation may be introduced in the markup and the CSS may be manipulated according to predefined rules to receive the desired result.

Next at 212, the Mobile Enabling Program 116A, 116B (FIG. 1) deploys a virtual mobile enabled web application not inherently built for the mobile device. Therefore, the present embodiment may convert the desktop based website into a “mobile site” without any knowledge or changing the website's design. Then, the method may proceed back to previously described step 202 to intercept content, including parameters associated with a request or a response between a web browser and application.

It may be appreciated that FIG. 2 provides only an illustration of one implementation and does not imply any limitations with regard to how different embodiments may be implemented. Many modifications to the depicted environments may be made based on design and implementation requirements. For example, as previously described, according to at least one implementation, the response may be intercepted and an algorithm may be run to modify the response received as per the layout of the device where the request originated. However, according to an alternate implementation, the response can be intercepted and additional code may be introduced which could add device capability and convert the web application into a hybrid application.

The present embodiment may be an advantage for “black box” legacy web applications since the various implementations do not risk application redesign and do not require a large investment. The present embodiment seamlessly converts (without storing) web content via a pre-created rules engine to convert the web content and renders it to a mobile device. As such, the present embodiment may quickly enable less complex web applications to be easily rendered and also be made to exploit HTML5 APIs supported by mobile devices. Rendering on mobile devices is a factor of correct styling and client-side dynamic behavior with some dependency on resource types and sizes and the present embodiment allows these features to be accessible from outside the “black-box” so that they can be modified.

Some of the current techniques require either custom code to be written in existing web sites or need a new URL deployment to detect and redirect users to mobile version of the site. The present embodiment is different from that since there is no modification of an existing website and no new URL needs to be setup and configured. Additionally, current techniques may use a proxy. However according to various implementations of the present embodiment, a reverse proxy is used which may have a large number of advantages over a proxy, especially when dealing with the case of mobile device rendering.

More specifically, the present embodiment relates to using the reverse proxy technology and, as such, the client need not be aware of the lack of mobile-friendliness of the application. The reverse proxy ensures that the client gets the differentiated UX transparently since the user does not know where the content is being fetched from or which back-end the content is coming from. This may be a security advantage when using a reverse proxy since the source of the content being rendered is hidden.

With respect to using the proxy approach there would be a need to have different URLs for desktop and mobile enabled content. However, using reverse proxy as described with respect to the present embodiment, there is a single URL and the reverse proxy decides which type of content to send by introspecting headers or using media queries. Furthermore, in a proxy, each mobile platform may also end up having a different or a “decorated” URL. For example, it could be m.xx.mywebsite.com or m.yy.mywebsite.com, and this would need additional web server configuration as well as new applications being deployed to render the mobile content. Conversely, with respect to a reverse proxy, none of these would be required and a single URL would end up rendering content specific to the device type requesting it.

Also, regarding the reverse proxy, rules take down or new rule activation may be faster, dynamic, and more serviceable than that in a proxy. For example, in a proxy, less programming logic and more xml configuration is required which may limit the amount of things that can be done and may even make it slower since every time a rule needs to be changed, the proxy needs to be brought down, the configuration xml needs to be changed, and the proxy needs to be again brought up. However, in a reverse proxy, more programming logic is used, and therefore, rules can be enabled or disabled using check-boxes or radio buttons in the user interface (UI) itself which may make reverse proxy more dynamic.

Taking into account scenarios where a new device is to be allowed to send requests, a new proxy may be required (when using a proxy) to be setup each time a new mapping of a URL to content for a device is required. However, in the case of a reverse proxy, the new device would also get served through the same reverse proxy. As such, the present embodiment deals with using existing resources to create new layouts as per device viewports, thus saving on multiple deployments to support multi-device presentation, whereas in a proxy, each layout on the device would require URL addressable pages and content since it does not have the capability to store content received from the server and render it selectively as requested. The reverse proxy allows to have a “spoon feeding” capability enabling caching of a complete page and then serve parts of it selectively on demand as needed.

More specifically, the present embodiment is concerned with web applications alone. The transformation does not involve storing different screen representations in its entirety which may serve a benefit over current techniques and the transformation may be applied as an overlay using CSS and js. Additionally, the transformation is dynamic; no markup type transformation required, and there is no need of an infrastructure requiring a separate server that handles data and the screen separately. Furthermore, the present embodiment is applicable for both the server side and the client side transformation. As such, two way transformation of data format is not required. Although the present embodiment requires injection of js and CSS into the markup, the present embodiment does not require injection on the web application server, but at a stage before it being finally rendered on the browser. As a result, the present embodiment pertains to markup transformation for display on various mobile devices not intended originally by the web application.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may be represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer/mobile device 102 (FIG. 1) and network server 114 (FIG. 1) may include respective sets of internal components 800 a,b and external components 900 a,b illustrated in FIG. 3. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) and the Mobile Enabling Program 116A (FIG. 1) in client computer/mobile device 102 (FIG. 1) and the Mobile Enabling Program 116B (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Mobile Enabling Program 116A, 116B (FIG. 1) can be stored on one or more of the respective portable computer-readable tangible storage devices 936, read via the respective R/W drive or interface 832 and loaded into the respective hard drive 830.

Each set of internal components 800 a,b also includes network adapters or interfaces 836 such as a TCP/IP adapter cards, wireless Wi-Fi interface cards, or 3G or 4G wireless interface cards or other wired or wireless communication links. The Software Program 108 (FIG. 1) and the Mobile Enabling Program 116A (FIG. 1) in client computer/mobile device 102 (FIG. 1) and the Mobile Enabling Program 116B (FIG. 1) in network server 114 (FIG. 1) can be downloaded to client computer/mobile device 102 (FIG. 1) and network server 114 (FIG. 1) from an external computer via a network (for example, the Internet, a local area network or other, wide area network) and respective network adapters or interfaces 836. From the network adapters or interfaces 836, the Software Program 108 (FIG. 1) and the Mobile Enabling Program 116A (FIG. 1) in client computer/mobile device 102 (FIG. 1) and the Mobile Enabling Program 116B (FIG. 1) in network server 114 (FIG. 1) are loaded into the respective hard drive 830. The network may comprise copper wires, optical fibers, wireless transmission, routers, firewalls, switches, gateway computers and/or edge servers.

Each of the sets of external components 900 a,b can include a computer display monitor 920, a keyboard 930, and a computer mouse 934. External components 900 a,b can also include touch screens, virtual keyboards, touch pads, pointing devices, and other human interface devices. Each of the sets of internal components 800 a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

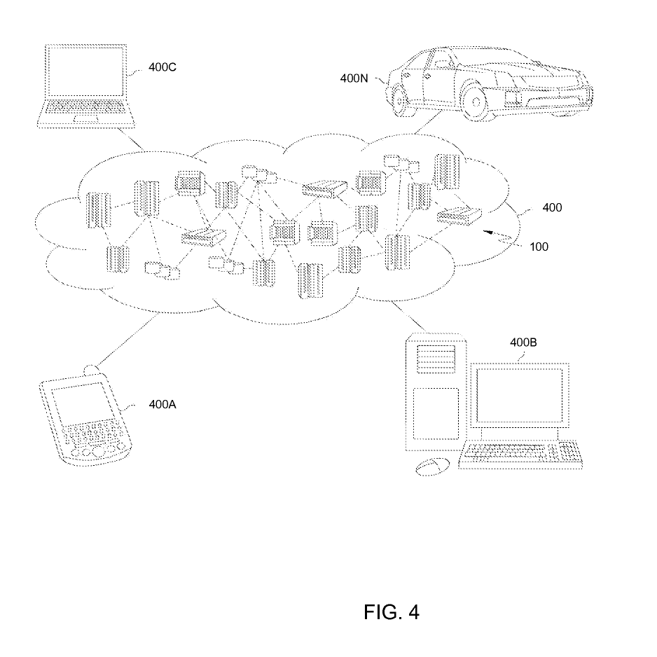

Referring now to FIG. 4, illustrative cloud computing environment 400 is depicted. As shown, cloud computing environment 400 comprises one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 100 and cloud computing environment 400 can communicate with any type of computerized device over any type of network and/or network addressable connection (e.g., using a web browser).

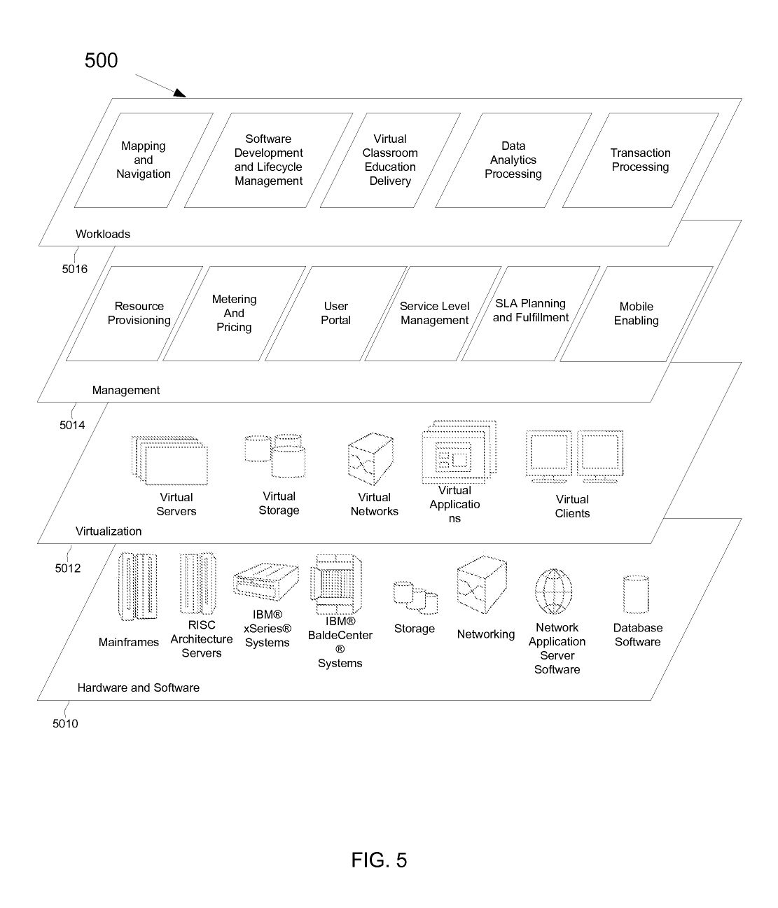

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 5010 includes hardware and software components. Examples of hardware components include: mainframes; RISC (Reduced Instruction Set Computer) architecture based servers; storage devices; networks and networking components. In some embodiments, software components include network application server software.

Virtualization layer 5012 provides an abstraction layer from which the following examples of virtual entities may be provided: virtual servers; virtual storage; virtual networks, including virtual private networks; virtual applications and operating systems; and virtual clients.

In one example, management layer 5014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A Mobile Enabling Program may provide a capability to mobile enable web applications that are not natively developed for mobile devices, such as smart phones.

Workloads layer 5016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for mobile enabling a web application, wherein the web application was developed without a mobile rendering capability, the method comprising:
intercepting a plurality of content between a web browser and a web application;
checking a user agent from which the intercepted plurality of content is being received;
determining whether the user agent is a mobile device based on the checking;
modifying or replacing a plurality of parameters associated with the intercepted plurality of content based on the determination that the user agent is a mobile device; and
deploying the modified or replaced parameters via a virtual mobile enabled web application.

2. The method of claim 1, wherein the intercepted content includes a request or a response and a plurality of parameters associated with the request or the response.

3. The method of claim 1, wherein the intercepted plurality of content is modified by an algorithm according to a layout of the user agent.

4. The method of claim 1, wherein the modifying or replacing the plurality parameters associated with the intercepted plurality of content comprises converting a desktop based website associated with a non-mobile device into a website for a mobile device.

5. The method of claim 1, further comprising:
parsing a DOM associated with the intercepted plurality of content.

6. The method of claim 1, further comprising:
detecting a plurality of device characteristics associated with the user agent; and
transforming a user experience and a behavior based on the detected plurality of device characteristics.

7. The method of claim 1, further comprising:
extracting a plurality of style declarations from a web page markup associated with the intercepted plurality of content; and
writing the extracted plurality of style declarations to a new CSS file.

8. A computer system for mobile enabling a web application, wherein the web application was developed without a mobile rendering capability, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
intercepting a plurality of content between a web browser and a web application;
checking a user agent from which the intercepted plurality of content is being received;
determining whether the user agent is a mobile device based on the checking;
modifying or replacing a plurality of parameters associated with the intercepted plurality of content based on the determination that the user agent is a mobile device; and
deploying the modified or replaced parameters via a virtual mobile enabled web application.

9. The computer system of claim 8, wherein the intercepted content includes a request or a response and a plurality of parameters associated with the request or the response.

10. The computer system of claim 8, wherein the intercepted plurality of content is modified by an algorithm according to a layout of the user agent.

11. The computer system of claim 8, wherein the modifying or replacing the plurality parameters associated with the intercepted plurality of content comprises converting a desktop based website associated with a non-mobile device into a website for a mobile device.

12. The computer system of claim 8, further comprising:
parsing a DOM associated with the intercepted plurality of content.

13. The computer system of claim 8, further comprising:
detecting a plurality of device characteristics associated with the user agent; and
transforming a user experience and a behavior based on the detected plurality of device characteristics.

14. The computer system of claim 8, further comprising:
extracting a plurality of style declarations from a web page markup associated with the intercepted plurality of content; and
writing the extracted plurality of style declarations to a new CSS file.

15. A computer program product for mobile enabling a web application, wherein the web application was developed without a mobile rendering capability, the computer program product comprising:
one or more computer-readable storage devices and program instructions stored on at least one of the one or more tangible storage devices, the program instructions executable by a processor, the program instructions comprising:
program instructions to intercept a plurality of content between a web browser and a web application;
program instructions to check a user agent from which the intercepted plurality of content is being received;
program instructions to determine whether the user agent is a mobile device based on the checking;
program instructions to modify or replacing a plurality of parameters associated with the intercepted plurality of content based on the determination that the user agent is a mobile device; and
program instructions to deploy the modified or replaced parameters via a virtual mobile enabled web application.

16. The computer program product of claim 15, wherein the intercepted content includes a request or a response and a plurality of parameters associated with the request or the response.

17. The computer program product of claim 15, wherein the intercepted plurality of content is modified by an algorithm according to a layout of the user agent.

18. The computer program product of claim 15, wherein the modifying or replacing the plurality parameters associated with the intercepted plurality of content comprises converting a desktop based website associated with a non-mobile device into a website for a mobile device.

19. The computer program product of claim 15, further comprising:
program instructions to parse a DOM associated with the intercepted plurality of content.

20. The computer program product of claim 15, further comprising:
program instructions to detect a plurality of device characteristics associated with the user agent; and
program instructions to transform a user experience and a behavior based on the detected plurality of device characteristics.
